(19) United States
(12) Patent Application Publication
(10) Pub. No.: US 2015/0056413 A1
(43) Pub. Date: Feb. 26, 2015

(54) OPTICAL SHEET

(71) Applicant: KOLON INDUSTRIES, INC., Gwacheon-si, Gyeonggi-do (KR)

(72) Inventors: Hong Gu Hwang, Incheon (KR); Kyung Jong Kim, Yongin-si (KR); Eui Young Shin, Seongnam-si (KR); Chang Won Park, Yongin-si (KR); Tae Kyung Kim, Yongin-si (KR); Su Ji Kim, Seoul (KR)

(73) Assignee: KOLON INDUSTRIES, INC., Gwacheon-si, Gyeonggi-do (KR)

(21) Appl. No.: 14/387,311

(22) PCT Filed: Mar. 29, 2013
(86) PCT No.: PCT/KR2013/002608

§ 371 Date: Sep. 23, 2014

(30) Foreign Application Priority Data
Mar. 29, 2012 (KR) 10-2012-0032319
Mar. 29, 2013 (KR) 10-2013-0034043

(51) Int. Cl. G02B 1/04; G02B 1/10; G02B 5/04

(52) U.S. Cl. CPC G02B 1/04; G02B 5/04; G02B 1/10
USPC 428/156; 428/206; 428/98

(57) ABSTRACT

The present invention relates to an optical sheet used in a liquid crystal display device, and relates to an optical sheet which comprises a resin curing layer made of a curable resin composition comprising metal oxide nanoparticles, and thus is easy to handle and not liable to be damaged from external shocks, and can prevent reduction in luminance due to damage and at the same time achieve a high refractive index.

### TECHNICAL FIELD

The present invention relates to an optical sheet useful for a liquid crystal device (LCD).

### BACKGROUND ART

LCDs, which are used as optical display devices, are operated in an indirect manner such that an image is displayed by controlling the transmissivity of an external light source, and a backlight unit is used as an external light source and is an important part determining the characteristics of LCDs.

Particularly, the advance of technologies for constructing LCD panels has led to a demand for thinner and brighter LCDs, which again has incited various attempts at increasing the luminance of backlight units. One of the evaluation factors of LCDs, which are used as monitors, PDAs (Personal Digital Assistant), laptop computers, etc., is the ability to display contents brightly using minimal energy. For LCDs, accordingly, the bright appearance of visible images is very important.

In the structure of LCD, the panel is lit by a backlight unit, and then a diffuser spreads the light out evenly across the whole display. Hence, the light emitting out of the whole display is much smaller in luminous density than the light source. To achieve higher brightness on the display with lower power consumption, many attempts have been made. Along with the enlargement of displays, much effort has been directed toward wide viewing angle for more viewers to view acceptable visual performance on the enlarged displays.

When the goals are attained by increasing the power of the backlight unit, power consumption also increases, together with the increase of power dissipation by heat. In this regard, mobile displays require enlarged battery capacities or quickly discharge the battery.

As a solution for improving the brightness, a method of providing the diffused light with directionality has been suggested. To this end, various lens sheets have been developed. Representative among the lens sheets is a sheet with an array of prisms, that is, an array of linear prism patterns, on the surface thereof.

Here, the prism structure is a triangular array structure having an incline of 45° to improve brightness in a front direction. However, the prism sheet is problematic in that since the prism structure resembles a mountain, its apex may be easily broken or abraded by weak external scratching, thus damaging the prism structure. Since the angles at which the light is emitted from the prism structures of the same shape are identical with respect to each array, brightness is reduced and defects are formed due to the differences in the light path between a damaged portion and a normal portion even when the corners of a triangle are somewhat crushed and the inclines of the triangle are slightly scratched. Therefore, the front face of the produced prism sheet may not be used depending on positions where even slight defects are formed at the time of producing the prism sheet, which results in a decrease in productivity and an increase in production cost. Actually, manufacturers which assemble backlight modules considerably suffer from high defective rates attributable to damage to prism structures by scratches caused when the prism sheets are handled.

Generally, an optical sheet with prism patterns is made of a resin, which is composed of organic compounds. Theoretically, organic compounds are known to have a controllable refractive index of up to 1.7, which is lower than the upper limit of the controllable refractive index for inorganic compounds. In addition, highly refractive resins composed only of organic compounds are apt to face many difficulties due to their inherent high viscosity, low UV stability, etc.

To overcome these problems, research has recently been directed towards the development of resins which are transparent and have high refractive indices by dispersing inorganic nanoparticles of high reflective index in the resins. The inorganic particles of high refractive index may be exemplified by TiO₂, and ZrO₂. A transparent resin with high refractive index can be obtained by dispersing therein inorganic nanoparticles smaller in size than 380 nm, the lower limit of the wavelength range of visible light. However, optical sheets with such organic nanoparticles dispersed therein may be readily damaged by external impact.

There is therefore a need for an optical sheet that is resistant to external impact and exhibits a high refractive index.

### DISCLOSURE

### Technical Problem

The present invention aims to provide an optical sheet superior in both refractivity and elasticity.

### Technical Solution

In accordance with a preferred embodiment thereof, the present invention provides to an optical sheet that comprises a resin cured layer, composed of a curable resin composition containing an organic compound and metal oxide nanoparticles, with a structured surface, and which exhibits an elastic recovery rate of 80% or higher, as represented by the following mathematical formula when a pressure is applied to the structured surface of the optical sheet at a pressing speed of 0.2031 mN/sec up to a maximum compression force of 1 gf or 2 gf using a flat indenter, maintained at the maximum compression force for 5 sec, and then released:

$$Elastic Recovery Rate = \frac{{D}_{1} - {D}_{2}}{{D}_{1}} \times 100 \qquad Mathematical Formula 1$$

wherein D₁ is a depth to which the optical sheet is indented by external pressure, and D₂ is a difference between the heights of the optical sheet before the application of a pressure to the optical sheet and after the application of the pressure to the optical sheet and then release of the pressure from the optical sheet.

In the embodiment, the organic compound may be is an acrylate-based organic compound that comprises a compound containing ethylene oxide and a benzene ring.

In the embodiment, the organic compound is represented by the following Chemical Formula 1:

X—Y Chemical Formula 1

wherein,

X is

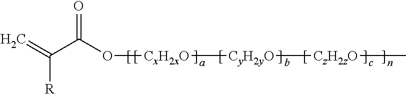

wherein R is a hydrogen atom or an alkyl group of 1˜15 carbon atoms, n is an integer of 1 or greater, a,b and c are each an integer of 0 or greater, with provision of a+b+c≧1, x, y and z are each an integer of 0 to 50, and

Y is a compound containing at least one benzene ring:

Mathematical Formula 1

[symbol]

In the embodiment, the compound containing at least one benzene ring may be selected from among the compounds represented by the following chemical formulas 2 to 5:

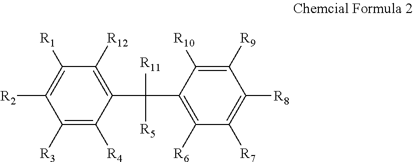

wherein, at least one of R₁ to R₁₂ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₁₂, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom:

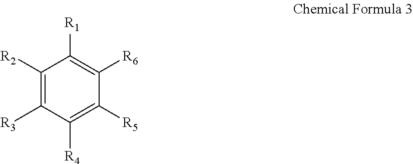

wherein, at least one of R₁ to R₆ is selected from among —C_{K}H_{2K}—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₆, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom:

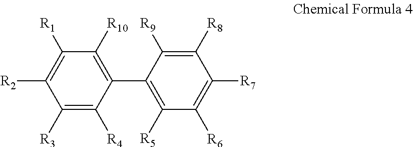

wherein, at least one of R₁ to R₁₀ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₁₀, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom:

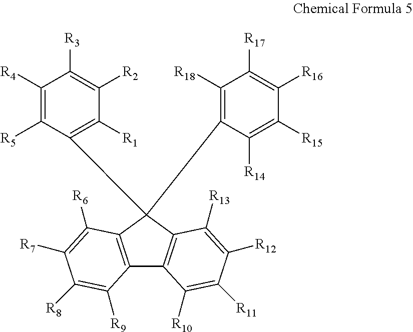

wherein, at least one of R₁ to R₁₈ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₁₈, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom.

In the embodiment, the optical sheet may exhibit an elastic recovery rate of 90% or higher.

In the embodiment, D₁ may meet the following mathematical formula 2:

$${D}_{1} > \frac{D}{8} \qquad Mathematical Formula 2$$

In the embodiment, D₁ may meet the following mathematical formula 3:

$${D}_{1} > \frac{D}{6} \qquad Mathematical Formula 3$$

In the embodiment, D₁ may meet the following mathematical formula 4:

$${D}_{1} > \frac{D}{3} \qquad Mathematical Formula 4$$

In the embodiment, the curable resin composition may further comprise a UV-curable monomer, a photoinitiator, and an additive.

In the embodiment, the structured surface of the resin cured layer may have a plurality of steric structures arranged in a linear or non-linear pattern thereon.

In the embodiment, the optical sheet may comprise a substrate layer.

In the embodiment, the structured surface of the resin cured layer may have a plurality of steric structures, each taking a form of a polyhedron, a cylinder, a curved cylinder, or a combination thereof, with a polygonal, semicircular, or semi-oval cross section.

In the embodiment, the metal oxide nanoparticles may be made of at least one metal oxide selected from the group consisting of Al₂O₃, TiO₂, ZrO₂, In₂O₃, SnO₂, Y₂O₃, CaO, MgO, and CeO₂.

In the embodiment, the metal oxide nanoparticles are contained in an amount of 5˜90%, based on the total weight of the resin cured layer.

In the embodiment, the metal oxide nanoparticles may be contained in an amount of 10˜70%, based on the total weight of the resin cured layer.

In the embodiment, the organic compound may be contained in an amount of 10˜70% by weight, based on the total weight of the resin cured layer.

In the embodiment, the optical sheet has a refractive index of 1.53˜1.65.

### Advantageous Effects

According to the present invention, as described above, an optical sheet superior in both refractive index and elasticity can be fabricated. Thanks to the properties thereof, the optical sheet can protect the structure layer upon lamination with a film or from external impact, so that it can prevent a damage-induced decrease of brightness and maintain its function.

### DESCRIPTION OF DRAWINGS

FIG. 1 schematically illustrates a test for an elastic recovery rate of an optical sheet.

FIG. 2 is a graph showing correlation of forces applied to a polymeric material superior in elastic recovery rate with D₁ and D₂.

FIG. 3 is a graph showing correlation of forces applied to a polymeric material inferior in elastic recovery rate with D₁ and D₂.

FIG. 4 is a schematic view illustrating scratching an optical sheet of the present invention with a scratching probe.

FIG. 5 is a schematic view illustrating scratching a conventional optical sheet with a scratching probe.

### BEST MODE

The present will be explained in detail, below.

The present invention addresses an optical sheet comprising an organic compound and metal oxide nanopaticles responsible for elasticity and refractivity of the optical sheet, respectively. In detail, the organic compound may be an acrylate-based organic compound comprising a compound containing ethylene oxide and a benzene ring.

The optical sheet of the present invention may comprise a resin cured layer having a structured surface (hereinafter referred to as “structure layer”), which may be provided for a substrate layer at one side or opposite sides. The structure layer, that is, the resin cured layer whose surface is structured, may comprise a plurality of steric structures.

In general, when an optical sheet comprises a structure layer on which a plurality of steric structures, each having a polygonal cross section, are formed, the peaks of the mountain-like steric structures become vulnerable to external impact. Existence of a lot of metal oxide nanoparticles in the resin cured layer aggravates vulnerability to external impact.

However, the optical sheet of the present invention, even if containing a lot of metal oxide nanoparticles, is not readily damaged by external impact because the optical sheet provided with elasticity by the organic compound is flexibly deformed by external force and then readily recovered.

In this regard, the optical sheet of the present invention exhibits an elastic recovery rate of 80% or higher, as represented by the following mathematical formula when a pressure is applied to the structured surface of the optical sheet at a pressing speed of 0.2031 mN/sec up to a maximum compression force of 1 gf or 2 gf using a flat indenter, maintained at the maximum compression force for 5 sec, and then released:

$$Elastic Recovery Rate = \frac{{D}_{1} - {D}_{2}}{{D}_{1}} \times 100 \qquad Mathematical Formula 1$$

wherein D₁ is a depth to which the optical sheet is indented by external pressure, and D₂ is a difference between the heights of the optical sheet before the application of a pressure to the optical sheet and after the application of the pressure to the optical sheet and then release of the pressure from the optical sheet.

Preferably, the optical sheet has an elastic recovery rate of 90% or higher.

If satisfying the elastic recovery rate after the compression is applied and then released, the optical sheet is elastic enough to flexibly cope with external impact, thus preventing the structure layer from being damaged.

On the other hand, if not satisfying the elastic recovery rate after the compression is applied and then released, the optical sheet is unlikely to normally function because the upper portion of the structure layer remains indented when the optical sheet is brought into contact with a film, or is imparted with a load.

In a preferred embodiment of the optical sheet according to the present invention, D₁, a depth to which the optical sheet is indented by external pressure, meets the following mathematical formula 2:

$${D}_{1} > \frac{D}{8} \qquad Mathematical Formula 2$$

More particularly, D₁ may meet the following mathematical formula 3:

$${D}_{1} > \frac{D}{6} \qquad Mathematical Formula 3$$

Even more particularly, D₁ may meet the following mathematical formula 4:

$${D}_{1} > \frac{D}{3} \qquad Mathematical Formula 4$$

In Mathematical Formulas 2 to 4, D means a height of the optical sheet to which no external pressure is applied.

That is to say, advantageous is the flexible optical sheet pitted by an external impact to the degree of ⅛ or greater of the height of the intact optical sheet loaded with no external pressure because the upper portion of its structure layer can keep the normal morphology even when the optical sheet is in contact with a film or is imparted with a load.

As things turn out, a high load readily indents the structure layer having steric structures in the optical sheet of the present invention, but when the compression is released, the structure layer can be reverted nearest to the original state so that it is unlikely to be damaged by external impact.

To provide an optical sheet meeting the elastic recovery rate, the structure layer contains an intramolecular polyalkylene glycol chain in accordance with the present invention. Particularly, when the curable resin composition, which is a material for the structure layer, contains an organic compound represented by the following Chemical Formula, the optical sheet advantageously meets the elastic recovery rate without degradation in optical properties:

X—Y Chemical Formula 1

wherein,

X is

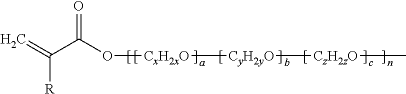

wherein R is a hydrogen atom or an alkyl group of 1˜15 carbon atoms, n is an integer of 1 or greater, a,b and c are each an integer of 0 or greater, with the provision of a+b+c≧1, x, y and z are each an integer of 0 to 50, and

Y is a compound containing at least one benzene ring.

In Chemical Formula 1, the compound containing at least one benzene ring may be selected from among the compounds represented by the following chemical formulas 2 to 5. However, the embodiments of the present invention are not limited only to the following structures, but optical sheets with high elasticity according to the present invention may be achieved by modifying the bridge of the compound containing at least one benzene ring.

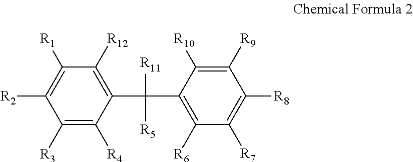

wherein, at least one of R₁ to R₁₂ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₁₂, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom.

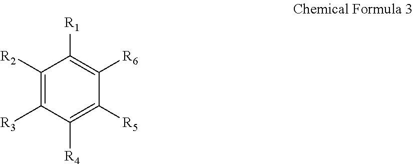

In Chemical Formula 3, at least one of R₁ to R₆ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₆, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom.

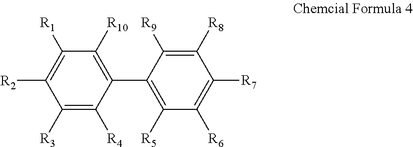

In Chemical Formula 4, at least one of R₁ to R₁₀ is selected from among —C_{K}H_{2K}O—, —C(═O)O—(CH₂)_{K}—CH(OH)—(CH₂) (CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to Rₙ, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom.

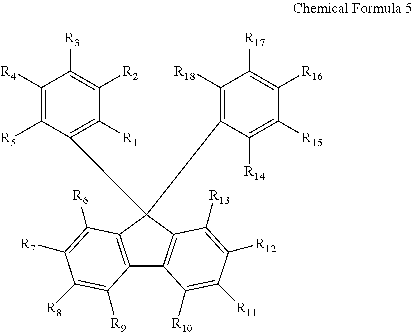

In Chemical Formula 5, at least one of R₁ to R₁₈ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,

the remaining moieties of R₁ to R₁₈, which are not linked to X of Chemical Formula 1, are independently a hydrogen atom; an alkyl of 1˜15 carbon atoms; an aromatic ring of 6˜30 carbon atoms; or a compound containing at least one selected from the group consisting of an oxygen atom, a nitrogen atom and a sulfur atom.

The curable resin composition useful for the formation of the structure layer preferably contains the compound represented by Chemical Formula 1 in an amount of 10˜70% by weight. Given the amount of the compound, the curable resin composition allows for the preparation of prism film resistant to process scratches. If the curable resin composition contains the compound of Chemical Formula 1 in an amount less than 10% by weight, it is difficult to achieve the desired elastic property with the curable resin composition. On the other hand, when the amount of the compound of Chemical Formula 1 exceeds 70% by weight, the sheet meets the desired elastic recovery rate, but may be degraded in other properties including brightness, color stability, process stability, etc.

The metal oxide nanoparticles contained in the curable resin composition may be made of at least one metal oxide selected from the group consisting of Al₂O₃, TiO₂, ZrO₂, In₂O₃, SnO₂, Y₂O₃, CaO, MgO, and CeO₂.

Preferably, the metal oxide nanoparticles account for 5˜90% by weight of the curable resin composition used for forming the structure layer. More particularly, the curable resin composition contains the metal oxide nanoparticles in an amount of 10˜70% by weight. This curable resin composition can be applied to the preparation of an optical sheet having high refractive index. If the content of the metal oxide nanoparticles in the curable resin composition is below 10% by weight, it is difficult to achieve a desired refractive property. When the content of the metal oxide nanoparticles exceeds 70% by weight, problems are found in forming prism patterns and achieving a desired elastic property of the resin.

Thanks of the metal oxide nanoparticles, the optical sheet can show a high refractive index, particularly, a refractive index of 1.53˜1.65.

For use in forming the structure layer of the optical sheet of the present invention, the curable resin composition may comprise, in addition to the organic compound of Chemical Formula 1 and the metal oxide nanoparticles, a UV-curable monomer. Examples of the UV-curable monomer includes tetrahydrofurfurylacrylate, 2(2-ethoxyethoxy)ethylacrylate, 1,6-hexanedioldi(meth)acrylate, benzyl(meth)acrylate, phenoxyethyl(meth)acrylate, 1,6-hexanedioldi(meth)acrylate, benzyl(meth)acrylate, phenoxyethyl(meth)acrylate, phenoxyepoxyethylene glycol(meth)acrylate, 2-hydroxy-3-phenoxypropylacrylate, neopentylglycolbenzoate acrylate, 2-hydroxy-3-phenoxypropylacrylate, phenylphenoxyethanolacrylate, caprolactone(meth)acrylate, nonylphenolpolyalkyleneglycol (meth)acrylate, trimethylpropanetri(meth)acrylate, styrene, methylstyrene, phenylepoxy(meth)acrylate and alkyl(meth)acrylate.

In addition, the curable resin composition applicable to the formation of the structure layer may further comprise an additive selected from the group consisting of a photoinitiator, such as phosphine oxide-, propanone-, ketone-, or formate-based photoinitiator, a UV absorbent, a UV stabilizer, a diluent, a color stabilizer, a leveling agent, an antioxidant, an antifoaming agent, an antistatic agent, and a combination thereof.

In the optical sheet of the present invention, the structure layer, which is a resin cured layer having a structured surface, has a plurality of steric structures that may take the form of a polyhedron, a cylinder, a curved cylinder, or a combination thereof, with a polygonal, semicircular, or semi-oval cross section.

Also, when viewed from the top, the structure layer may have at least one concentric array of steric structures, with the vertices and valleys formed along the concentric circle.

For the structure layer with a polygonal section, both the brightness and the wide viewing angle severely fluctuate with the vertex angle. In consideration of the brightness and wide viewing angle according to collimation, the vertex angle may be preferably 80°˜100°, and more preferably 85°˜95°.

The substrate layer of the optical sheet may be made of at least one selected from the group consisting of polyethyleneterephthalate, polyethylenenaphthalate, polycarbonate, polystyrene, polymethacrylate, polymethylmethacrylate, polyacrylate, polyimide, and polyamide, and may be of bumpy structure with light diffusion particles included therein.

No limitations are imparted to the fabrication of the optical sheet of the present invention. For example, the materials for the structure layer are mixed with a UV hardener to give a UV-curable liquid composition, which is then applied to the substrate layer and cured to yield an optical sheet.

Display devices to which the optical sheet is applied are easy to handle because the optical sheet is configured to protect the structure layer from external impact. Even for mobile displays such as in laptop computers, PDA, etc., the structure layer is unlikely to be damaged by the external impact occurring upon, for example, shaking in a bag, or sudden stop in a vehicle.

Moreover, the optical sheet enjoys the advantage of simplifying fabrication processes thereof, decreasing the production cost, and increasing production yield because it does not need a separate protective film.

Further, the optical sheet is resistant to damage upon film lamination or external impact, and thus is low in defective rate, which leads to an improvement in production cost and yield.

Below, a detailed description will be given of the present invention in conjunction with the following drawings.

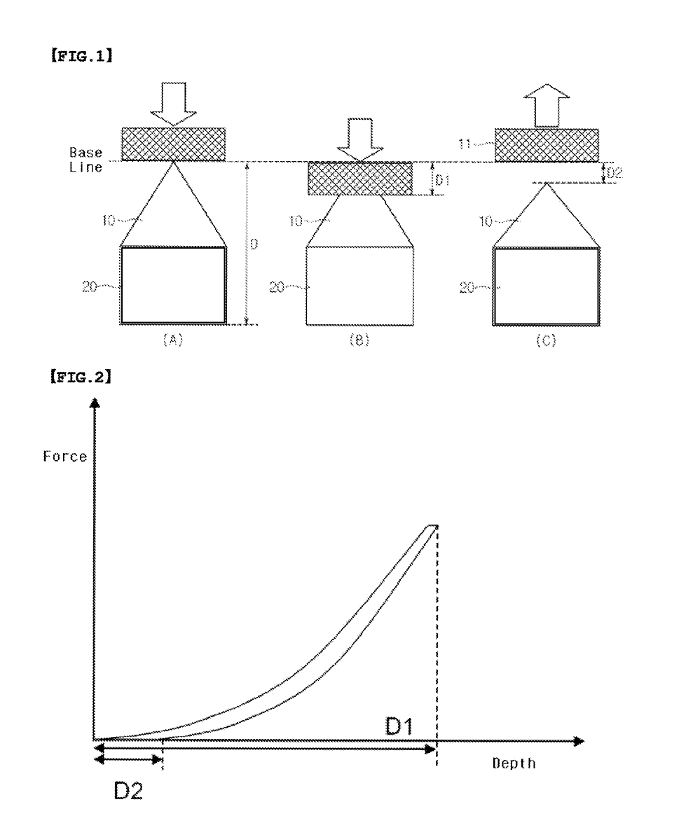

FIG. 1 schematically illustrates a test for an elastic recovery rate of an optical sheet.

Application of a force to a structure layer 10 of an optical sheet using a flat indenter 11 (A) compresses the upper surface of the structure layer 10 to a depth D₁ (B). In the optical sheet of the present invention, the ratio of D₁ to D, the height of the optical sheet to which no pressures are applied, is preferably greater than ⅛, more preferably ⅙, and even more preferably ⅓. In other words, the optical sheet of the present invention is flexible enough to pit as much as possible without being damaged by external impact.

Thereafter, removal of the flat indenter 11 reverts the upper face of the structure layer 10 nearest to the original state without being damaged (C). The difference of height between the reverted optical sheet and the intact optical sheet is designated D₂.

The greater the difference between the depth to which the optical sheet is compressed by external pressure and the height of the reverted optical sheet (D₁-D₂), the better the elasticity of the optical sheet. The optical sheet of the present invention exhibits an elastic recovery rate of 80% or greater, and preferably 90% or greater, as represented by Mathematical Formula 1, and has a large value for (D₁-D₂) as well as D₁. Hence, being superior in elasticity, the optical sheet of the present invention pits much upon external impact and then reverts nearest to the original state.

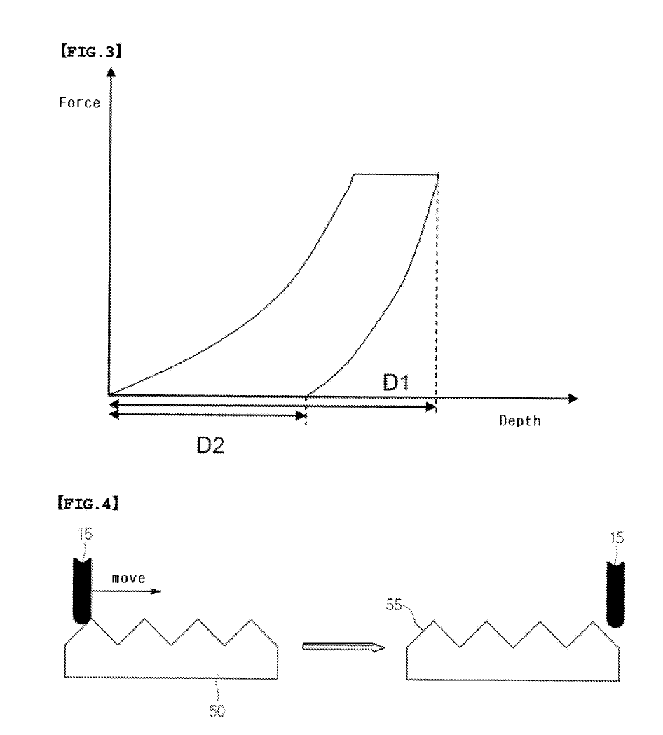

FIG. 2 is a graph showing correlation of forces applied to a polymeric material superior in elastic recovery rate with D₁ and D₂ while FIG. 3 is a graph showing correlation of forces applied to a polymeric material inferior in elastic recovery rate with D₁ and D₂. Materials with higher elastic recovery rates render D₂ nearer zero. A material with ideal elasticity makes D₂=0, exhibiting an elastic recovery rate of 100%. In contrast, a material with poorer elasticity makes D₂ nearer D₁, so that (D₁-D₂) approximates to 0.

The optical sheet of the present invention exhibits, but is not limited to the plot of FIG. 2.

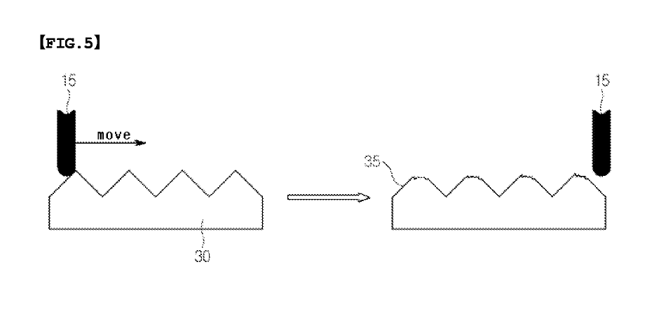

FIG. 4 is a schematic view illustrating scratching an optical sheet 50 of the present invention with a scratching probe 15 while FIG. 5 is a schematic view illustrating scratching a conventional optical sheet 30 with a scratching probe 15.

As can be seen, the upper portion of the structure layer in the conventional optical sheet 30 is irreversibly deformed or damaged by scratching with the probe 15. In contrast, no damages are found in the upper portion of the structure layer 55 after the optical sheet of the present invention experiences the scratching process.

The resin cured layer of the optical sheet according to the present invention comprises an organic compound in an amount of 10˜70% by weight, metal oxide nanoparticles in an amount of 10˜70% by weight, a UV curable monomer in an amount of 10˜50% by weight, a photoinitiator in an amount of 1˜5% by weight, and an additive in an amount of 1˜5% by weight, thus exhibiting both elasticity and refractivity.

### MODE FOR INVENTION

A better understanding of the present invention may be obtained through the following examples, which are set forth to illustrate, but are not to be construed as limiting the present invention.

### Preparation of Acrylate Oligomer

### Synthesis Example 1

In a reflex reactor filled with nitrogen, 500 g of toluene, 14 ml of triethylamine, 39.3 g (0.1 mol) of bisphenol A bischloroformate (Aldrich), and 75.0 g (0.2 mol) of polyethyleneglycol acrylate (Aldrich, number average molecular weight 375) were reacted at 50° C. for 24 hrs. The salt thus formed was separated by centrifugation and the solvent and unreacted materials were removed at reduced pressure by distillation to yield an acrylate oligomer represented by Chemical Formula 1 wherein n=2, R is H, x=2, y=z=0, a is 9, b=c=0, and Y is an compound of Chemical Formula 2 wherein R₂ and R₈ are each —OCH₂—, R₅ and R₁₁ are each CH₃, and the remaining Rs are each H.

### Synthetic Example 2

In a reflex reactor filled with nitrogen, 9.4 g of phenol (Aldrich), 28.8 g of epoxy butane (Aldrich), and 0.05 g of benzyltriethylammonium chloride were added to 200 g of toluene, and reacted at 90° C. for 24 hrs, and the reaction mixture was further reacted with 15.51 g of isocyanatoethylmethacrylate (Aldrich) at 60° C. for 24 hrs in the presence of 0.05 g of the catalyst dibutyltin dilaurate (Aldrich), followed by removing unreacted materials and the solvent through distillation at a reduced pressure to yield an acrylate oligomer represented by Chemical Formula 1 wherein n=1, R is CH₃, x=4, y=z=0, a=4, b=c=0, and Y is a compound of Chemical Formula 3 wherein R₁ is —CH₂NHC(═O)— and R₂ to R₆ are each H.

### Synthetic Example 3

In a reflex reactor filled with nitrogen, 200 g of toluene, 92 g (0.1 mol) of polypropyleneglycol monoacrylate (BISOMER PPA6, LARPORTE), 0.04 g of tin chloride (Aldrich), and 10.17 g of epichlorohydrin (0.11 mol, Aldrich) were stirred at 80° C. for 24 hrs, followed by desalination with an aqueous 50% NaOH solution. Then, NaCl was removed using a separatory funnel before vacuum distillation. The resulting product was dissolved in an amount of 47.9 g (0.05 mol) in 200 g of toluene, and reacted with 10.1 g of 2-biphenylcarboxylic acid (0.051 mol, Aldrich) and 0.05 g of benzyl triethylammonium chloride at 90° C. for 24 hrs, after which unreacted materials and the solvent were removed by vacuum distillation to afford an acrylate oligomer represented by Chemical Formula 1 wherein n=1, R is H, x=3, y=z=0, a is 5, b=c=0, and Y is a compound of Chemical Formula 4 wherein R₂ is —CH₂NHC(═O)—, R₁, R₃, R₄, R₅ and R₆ are each H.

### Synthetic Example 4

In a reflex reactor filled with nitrogen, 500 g of toluene, 14 ml of triethylamine, 35.4 g (0.1 mol) of bisphenol fluorene (Osaka Gas, BPF), and 75.0 g (0.2 mol) of polyethyleneglycol acrylate (Aldrich, number average molecular weight 375) were reacted at 50° C. for 24 hrs, and the resulting salt was separated by centrifugation, and unreacted materials and the solvent were removed by vacuum distillation to afford an acrylate oligomer represented by Chemical Formula 1 wherein n=2, R is H, x=2, y=z=0, a is 6, and b=c=0, and Y is a compound of Chemical Formula 5 wherein R₃ and R₁₆ are each —OCH₂—, and the remaining Rs (R₁, R₂, R₄ to R₁₅) are each H.

### Synthetic Example 5

In a reflex reactor filled with nitrogen, 500 g of toluene, 14 ml of triethylamine, 39.3 g (0.1 mol) of bisphenol A bischloroformate (Aldrich), and 160.0 g (0.2 mol) of polyethyleneglycol acrylate (Aldrich, number average molecular weight 800) were reacted at 50° C. for 24 hrs, and the resulting salt was separated by centrifugation, and unreacted materials and the solvent were removed by vacuum distillation to afford an acrylate oligomer represented by Chemical Formula 1 wherein n=2, R is H, x=2, y=z=0, a=15, b=c=0, and Y is a compound of Chemical Formula 2 wherein R₂ and R₈ are each —OCH₂—, and the remaining Rs (R₁, R₃, R₄, R₅, R₆, R₇, R₉, R₁₀, R₁₁, R₁₂ to R₁₈) are each H.

### Synthetic Example 6

In a reflex reactor filled with nitrogen, a solution of 34.0 g (0.1 mol) of bisphenyl A diglycidylether in 200 g of toluene was reacted with 160.0 g (0.2 mol) of polyethyleneglycol acrylate (Aldrich, number average molecular weight 800) in the presence of 0.05 g of benzyltriethylammonium chloride at 90° C. for 24 hrs, followed by removal of unreacted materials and the solvent by vacuum distillation to afford an acrylate oligomer represented by Chemical Formula 1 wherein n=2, R is H, x is 2, y=z=0, a=15, b=c=0, and Y is a compound of Chemical Formula 2 wherein R₂, and R₈ are each —CH₂—CH(OH)—CH₂O—, R₅ and R₁₁ are each CH₃, and the remaining Rs (R₁, R₃, R₄, R₆, R₇, R₉, R₁₀, R₁₂ to R₁₈) are each H.

### Synthetic Example 7

In a reflex reactor filled with nitrogen, a solution of 34.0 g (0.1 mol) of bisphenol A diglycidylether in 200 g of toluene was reacted with 160.0 g (0.2 mol) of polyethyleneglycol acrylate (Aldrich, number average molecular weight 800) in the presence of 0.05 g of benzyltriethylammonium chloride at 90° C. for 24 hrs, followed by removal of unreacted materials and the solvent by vacuum distillation to afford an acrylate oligomer represented by Chemical Formula 1 (Miwon Commercial Co. Ltd, M240) wherein n=2, R is H, x is 2, y=z=0, a=2, b=c=0, and Y is a compound of Chemical Formula 2 wherein R₂ and R₇ are each —OCH₂—, R₅ and R₁₁ are each CH₃, and the remaining Rs (R₁, R₃, R₄, R₆, R₈, R₉, R₁₀ to R₁₂) are each H.

### Fabrication of Optical Sheet

### Example 1

Using Vibratory Micro Mill (FRITSCH GmbH), 35% by weight of the acrylate prepared in Synthetic Example 1; 35% by weight of TiO₂ particles (Degussa, P25); 10% by weight of phenoxyethylmethacrylate (Sartomer, SR340) and 15% by weight of phenoxyethylacrylate (Sartomer, SR339), both serving as UV curable monomers; 1.5% by weight of 2,4,6-trimethylbenzoyl diphenylphosphine oxide, and 1.5% by weight of methylbenzoylformate, both serving as photoinitiators; and 2.0% by weight of the additive bis(1,2,2,6,6-pentamethyl-4-piperidyl)sebacate were mixed for 3 hrs to give a composition. This composition was applied to one side of a substrate layer made of polyethyelene terephthalate (KOLON, 188 μm thick), and then disposed on a frame of a prism-shaped roller maintained at 35° C. in such a way that the coating faced the roller. A UV irradiator (Fusion, 600 Watt/inch²) equipped with a type-D bulb irradiated UV beams at an intensity of 900 mJ/cm² on the coating in contact with the prism-shape roller from the side of the substrate layer to fabricate an optical sheet in which a pattern of linear triangular prisms, each having an vertex angle of 90°, a pitch of 50 μm, and a height of 27 μm, was formed (D=215 μm).

### Example 2

Using Vibratory Micro Mill (FRITSCH GmbH), 35% by weight of the acrylate prepared in Synthetic Example 1; 35% by weight of ZrO₂ particles (MEL Chemicals, MELox Nanosize Undoped); 10% by weight of phenoxyethylmethacrylate (Sartomer, SR340) and 15% by weight of phenoxyethylacrylate (Sartomer, SR339), both serving as UV curable monomers; 1.5% by weight of 2,4,6-trimethylbenzoyl diphenylphosphine oxide, and 1.5% by weight of methylbenzoylformate, both serving as photoinitiators; and 2.0% by weight of the additive bis(1,2,2,6,6-pentamethyl-4-piperidyl)sebacate were mixed for 3 hrs to give a composition. This composition was applied to one side of a substrate layer made of polyethyelene terephthalate (KOLON, 188 μm thick), and then disposed on a frame of a prism-shaped roller maintained at 35° C. in such a way that the coating faced the roller. A UV irradiator (Fusion, 600 Watt/inch²) equipped with a type-D bulb irradiated UV beams at an intensity of 900 mJ/cm² on the coating in contact with the prism-shape roller from the side of the substrate layer to fabricate an optical sheet in which a pattern of linear triangular prisms, each having an vertex angle of 90°, a pitch of 50 μm, and a height of 27 μm, was formed (D=215 μm).

### Example 3

An optical sheet was fabricated in the same manner as in Example 1, with the exception that the acrylate prepared in Synthetic Example 2 was used instead of the acrylate prepared in Synthetic Example 1.

### Example 4

An optical sheet was fabricated in the same manner as in Example 1, with the exception that the acrylate prepared in Synthetic Example 3 was used instead of the acrylate prepared in Synthetic Example 1.

### Example 5

An optical sheet was fabricated in the same manner as in Example 1, with the exception that the acrylate prepared in Synthetic Example 4 was used instead of the acrylate prepared in Synthetic Example 1.

### Example 6

An optical sheet was fabricated in the same manner as in Example 1, with the exception that the acrylate prepared in Synthetic Example 5 was used instead of the acrylate prepared in Synthetic Example 1.

### Example 7

An optical sheet was fabricated in the same manner as in Example 1, with the exception that the acrylate prepared in Synthetic Example 6 was used instead of the acrylate prepared in Synthetic Example 1.

### Comparative Example 1

BEFΠ-GΠ prism film from 3M was used as an optical sheet (D=215 μm).

### Comparative Example 2

Using Vibratory Micro Mill (FRITSCH GmbH), 70% by weight of the acrylate prepared in Synthetic Example 7, 10% by weight of phenoxyethylmethacrylate (Sartomer, SR340), 15% by weight of phenoxyethylacrylate (Sartomer, SR339), 1.5% by weight of the photoinitiator 2,4,6-trimethylbenzoyl diphenylphosphine oxide, 1.5% by weight of the photoinitiator methylbenzoylformate, and 2.0% by weight of the additive bis(1,2,2,6,6-pentamethyl-4-piperidyl)sebacate were mixed for 3 hrs to give a composition.

Subsequently, the composition was applied to one side of a substrate layer made of polyethyelene terephthalate (KOLON, 188 μm thick), and then disposed on a frame of a prism-shaped roller maintained at 35° C. in such a way that the coating faced the roller. A UV irradiator (Fusion, 600 Watt/inch²) equipped with a type-D bulb irradiated UV beams at an intensity of 900 mJ/cm² on the coating in contact with the prism-shape roller from the side of the substrate layer to fabricate an optical sheet in which a pattern of linear triangular prisms, each having an vertex angle of 90°, a pitch of 50 μm, and a height of 27 μm, was formed (D=215 μm).

### Comparative Example 3

Using Vibratory Micro Mill (FRITSCH GmbH), 70% by weight of the acrylate prepared in Synthetic Example 1; 10% by weight of phenoxyethylmethacrylate (Sartomer, SR340) and 15% by weight of phenoxyethylacrylate (Sartomer, SR339), both serving as UV curable monomers; 1.5% by weight of 2,4,6-trimethylbenzoyl diphenylphosphine oxide, and 1.5% by weight of methylbenzoylformate, both serving as photoinitiators; and 2.0% by weight of the additive bis(1,2,2,6,6-pentamethyl-4-piperidyl)sebacate were mixed for 3 hrs to give a composition. This composition was applied to one side of a substrate layer made of polyethyelene terephthalate (KOLON, 188 μm thick), and then disposed on a frame of a prism-shaped roller maintained at 35° C. in such a way that the coating faced the roller. A UV irradiator (Fusion, 600 Watt/inch²) equipped with a type-D bulb irradiated UV beams at an intensity of 900 mJ/cm² on the coating in contact with the prism-shape roller from the side of the substrate layer to fabricate an optical sheet in which a pattern of linear triangular prisms, each having an vertex angle of 90°, a pitch of 50 μm, and a height of 27 μm, was formed (D=215 μm).

### Comparative Example 4

Using Vibratory Micro Mill (FRITSCH GmbH), 60% by weight of the acrylate prepared in Synthetic Example 1; 5% by weight of TiO₂ particles (Degussa, P25); 10% by weight of phenoxyethylmethacrylate (Sartomer, SR340) and 15% by weight of phenoxyethylacrylate (Sartomer, SR339), both serving as UV curable monomers; 1.5% by weight of 2,4,6-trimethylbenzoyl diphenylphosphine oxide, and 1.5% by weight of methylbenzoylformate, both serving as photoinitiators; and 2.0% by weight of the additive bis(1,2,2,6,6-pentamethyl-4-piperidyl)sebacate were mixed for 3 hrs to give a composition. This composition was applied to one side of a substrate layer made of polyethyelene terephthalate (KOLON, 188 μm thick), and then disposed on a frame of a prism-shaped roller maintained at 35° C. in such a way that the coating faced the roller. A UV irradiator (Fusion, 600 Watt/inch²) equipped with a type-D bulb irradiated UV beams at an intensity of 900 mJ/cm² on the coating in contact with the prism-shape roller from the side of the substrate layer to fabricate an optical sheet in which a pattern of linear triangular prisms, each having an vertex angle of 90°, a pitch of 50 μm, and a height of 27 μm, was formed (D=215 μm).

### Comparative Example 5

Using Vibratory Micro Mill (FRITSCH GmbH), 10% by weight of the acrylate prepared in Synthetic Example 1; 80% by weight of TiO₂ particles (Degussa, P25); 2% by weight of phenoxyethylmethacrylate (Sartomer, SR340) and 3% by weight of phenoxyethylacrylate (Sartomer, SR339); 1.5% by weight of 2,4,6-trimethylbenzoyl diphenylphosphine oxide, and 1.5% by weight of methylbenzoylformate, both serving as photoinitiators; and 2.0% by weight of the additive bis(1,2,2,6,6-pentamethyl-4-piperidyl)sebacate were mixed for 3 hrs to give a composition. Subsequently, the composition was applied to one side of a substrate layer made of polyethyelene terephthalate (KOLON, 188 μm thick), and then disposed on a frame of a prism-shaped roller maintained at 35° C. in such a way that the coating faced the roller. A UV irradiator (Fusion, 600 Watt/inch²) equipped with a type-D bulb irradiated UV beams at an intensity of 900 mJ/cm² on the coating in contact with the prism-shape roller from the side of the substrate layer to fabricate an optical sheet in which a pattern of linear triangular prisms, each having an vertex angle of 90°, a pitch of 50 μm, and a height of 27 μm, was formed (D=215 μm).

TABLE 1

| | | | | | UV | | |
|---|---|---|---|---|---|---|---|
| | | | | | Curable | Photo- | |
| | | | Metal Oxide | | Mono- | initi- | Addi- |
| | Organic Cpd. | | Nanoparticle | | mer | ator | tive |
| | | Con- | | Con- | Con- | Con- | Con- |
| Ex. | | tent | | tent | tent | tent | tent |
| No. | Source | (Wt %) | Kind | (Wt %) | (Wt %) | (Wt %) | (Wt %) |
| 1 | Synthet- | 35 | TiO₂ | 35 | 25 | 3.0 | 2.0 |
| | ic Ex. 1 | | | | | | |
| 2 | Synthet- | 35 | TiO₂ | 35 | 25 | 3.0 | 2.0 |
| | ic Ex. 1 | | | | | | |
| 3 | Synthet- | 35 | TiO₂ | 35 | 25 | 3.0 | 2.0 |
| | ic Ex. 2 | | | | | | |
| 4 | Synthet- | 35 | TiO₂ | 35 | 25 | 3.0 | 2.0 |
| | ic Ex. 3 | | | | | | |
| 5 | Synthet- | 35 | TiO₂ | 35 | 25 | 3.0 | 2.0 |
| | ic Ex. 4 | | | | | | |
| 6 | Synthet- | 35 | TiO₂ | 35 | 25 | 3.0 | 2.0 |
| | ic Ex. 5 | | | | | | |
| 7 | Synthet- | 35 | TiO₂ | 35 | 25 | 3.0 | 2.0 |
| | ic Ex. 6 | | | | | | |
| C. 1 | BEF II-G II prism film from 3M | | | | | | |
| C. 2 | Synthet- | 70 | — | — | 25 | 3.0 | 2.0 |
| | ic Ex. 7 | | | | | | |
| C. 3 | Synthet- | 70 | — | — | 25 | 3.0 | 2.0 |
| | ic Ex. 1 | | | | | | |
| C. 4 | Synthet- | 60 | TiO₂ | 5 | 25 | 3.0 | 2.0 |
| | ic Ex. 1 | | | | | | |
| C. 5 | Synthet- | 10 | TiO₂ | 80 | 25 | 3.0 | 2.0 |
| | ic Ex. 1 | | | | | | |

Optical sheets fabricated in Examples and Comparative Examples were measured for D₁, elastic recovery rate, scratch resistance, and refractive index, and the results are summarized in Table 2.

(1) D₁ and elastic recovery rate

D₁ and elastic recovery rates of the optical sheets of Examples and Comparative Examples were measured using the microhardness tester (DUH-W201S), manufactured by Shimidazu Corp. of Japan, according to the load/unload test type. After the vertices of the structure layer of the optical sheet were aligned with the center of a flat indenter having a diameter of 50 mm, the optical sheet was measured five times for D1 and elastic recovery rate under the following conditions. In Table 2, mean values of the five measurements are given.

[Condition 1]

a. maximum compression force applied: 1 g_{f} (=9.807 mN)

b. compression force applied per second: 0.2031 mN/sec

c. retention time at the maximum compression force: 5 sec

[Condition 2]

a. maximum compression force applied: 2 g_{f} (=19.614 mN)

b. compression force applied per second: 0.2031 mN/sec

c. retention time at the maximum compression force: 5 sec

(2) Scratch Resistance

When minimum pressure was applied to the optical sheet of each of the examples and comparative examples using a standard weight of a Big Heart tester available from IMOTO, measurement was made to see whether the structured surface was scratched or not. The degree of damage was observed with the naked eye and was then evaluated according to the following:

Poor scratch resistance←x<Δ<◯<⊚→excellent scratch resistance

(3) Refractive Index

The composition was measured for refractive index, using a refractometer (1T, ATAGO ABBE, Japan) was used. For this, a D-light sodium lamp of 589.3 nm was employed as a light source. The refractive index was measured at 25° C.

TABLE 2

| | | Condition 1 | | | Condition 2 | | | | | |
|---|---|---|---|---|---|---|---|---|---|---|
| | | | | Elastic | | | Elastic | | Refractive | |
| Ex. | D | D₁ | D₂ | Recovery | D₁ | D₂ | Recovery | Scratch | Index of | |
| No. | (μm) | (μm) | (μm) | Rate (%) | (μm) | (μm) | Rate (%) | Resist. | Composition | Remark |
| 1 | 215 | 5.377 | 0.815 | 84.8 | 8.632 | 0.959 | 88.8 | ⊚ | 1.59 | |
| 2 | 215 | 5.421 | 0.952 | 82.4 | 8.798 | 0.961 | 89.0 | ⊚ | 1.58 | |
| 3 | 215 | 5.433 | 0.725 | 86.6 | 9.523 | 1.051 | 88.9 | ⊚ | 1.58 | |
| 4 | 215 | 6.254 | 0.891 | 85.7 | 10.583 | 0.956 | 90.9 | ⊚ | 1.58 | |
| 5 | 215 | 5.358 | 0.786 | 85.3 | 9.536 | 0.876 | 90.8 | ⊚ | 1.59 | |
| 6 | 215 | 4.896 | 0.689 | 85.9 | 9.577 | 0.952 | 90.0 | ⊚ | 1.59 | |
| 7 | 215 | 5.233 | 0.885 | 83.0 | 10.563 | 1.2 | 88.6 | ⊚ | 1.58 | |
| C. 1 | 215 | 1.338 | 0.383 | 71.3 | 2.53 | 0.697 | 72.4 | X | — | |
| C. 2 | 215 | 9.584 | 1.935 | 79.8 | 10.500 | 2.226 | 78.8 | ◯ | 1.54 | |
| C. 3 | 215 | 4.562 | 0.699 | 84.6 | 9.544 | 1.325 | 86.1 | ⊚ | 1.55 | |
| C. 4 | 215 | 5.241 | 0.722 | 86.2 | 10.33 | 1.553 | 84.9 | ⊚ | 1.56 | |
| C. 5 | 215 | — | — | — | — | — | — | — | Analysis | Impossible |
| | | | | | | | | | impossible | to fabri- |
| | | | | | | | | | | cate Prism |

As can be understood from the data of Table 2, the compositions containing the resin represented by Chemical Formula 1, and metal oxide nanoparticles exhibit high refractive indices, and allows prism sheets made thereof to have excellent scratch resistance. Employing the layer of high refractive index, the optical sheet of the present invention can therefore not only retain prism properties of high brightness, but also responds flexibly to external impact so that it allows the structures to pit and then revert nearest to the original state, without being damaged.

1. An optical sheet, comprising a resin cured layer made of a curable resin composition containing an organic compound and metal oxide nanoparticles, said resin cured layer having a structured surface, wherein the optical sheet exhibits an elastic recovery rate of 80% or higher, as represented by the following mathematical formula when a pressure is applied to the structured surface at a pressing speed of 0.2031 mN/sec up to a maximum compression force of 1 gf or 2 gf using a flat indenter, maintained at the maximum compression force for 5 sec, and then released:
$$Elastic Recovery Rate = \frac{{D}_{1} - {D}_{2}}{{D}_{1}} \times 100 \qquad Mathematical Formula 1$$
wherein D₁ is a depth to which the optical sheet is indented by external pressure, and D₂ is a difference between the heights of the optical sheet before the application of a pressure to the optical sheet and after the application of the pressure to the optical sheet and then release of the pressure from the optical sheet.

2. The optical sheet of claim 1, wherein the organic compound is an acrylate-based organic compound which comprises a compound containing ethylene oxide and a benzene ring.

3. The optical sheet of claim 1, wherein the organic compound is represented by the following Chemical Formula 1:
X—Y Chemical Formula 1
wherein,
X is 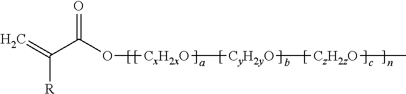
wherein R is a hydrogen atom or an alkyl group of 1˜15 carbon atoms, n is an integer of 1 or greater, a, b and c are each an integer of 0 or greater, with provision of a+b+c>1, x, y and z are each an integer of 0 to 50, and
Y is a compound containing at least one benzene ring:

4. The optical sheet of claim 3, wherein the compound containing at least one benzene ring is selected from among the compounds represented by the following chemical formulas 2 to 5: 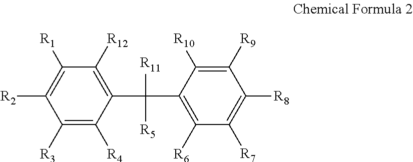
wherein, at least one of R₁ to R₁₂ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,
the remaining moieties of R₁ to R₁₂, which are not linked to X of Chemical Formula 1, are independently a hydrogen atom; an alkyl of 1-15 carbon atoms; an aromatic ring of 6-30 carbon atoms; or a compound containing at least one selected from the group consisting of an oxygen atom, a nitrogen atom and a sulfur atom: 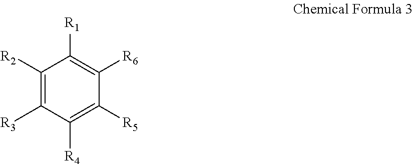
wherein, at least one of R₁ to R₆ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,
the remaining moieties of R₁ to R₆, which are not linked to X of Chemical Formula 1, are independently a hydrogen atom; an alkyl of 1-15 carbon atoms; an aromatic ring of 6-30 carbon atoms; or a compound containing at least one selected from the group consisting of an oxygen atom, a nitrogen atom and a sulfur atom: 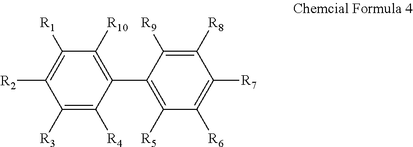
wherein, at least one of R₁ to R₁₀ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,
the remaining moieties of R₁ to R₁₀, which are not linked to X of Chemical Formula 1, are independently a hydrogen atom; an alkyl of 1-15 carbon atoms; an aromatic ring of 6-30 carbon atoms; or a compound containing at least one selected from the group consisting of an oxygen atom, a nitrogen atom and a sulfur atom: 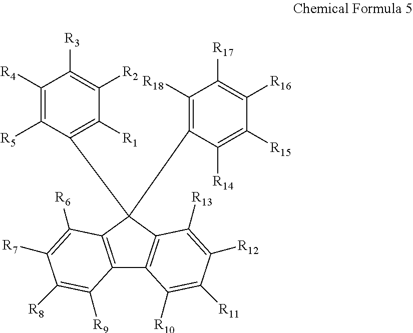
wherein, at least one of R₁ to R₁₈ is selected from among —C_{K}H_{2K}O—, —C(═O)O—(CH₂)_{K}—CH(OH)—(CH₂)_{K′}—, —(CH₂)_{K}—CH(OH)—(CH₂)_{K′}O—, and —CⱼH₂ⱼNHC(═O)— (wherein K and K′ are each an integer of 1 or greater, and j is an integer of 0 or greater), and is linked to X of Chemical Formula 1,
the remaining moieties of R₁ to R₁₈, which are not linked to X of Chemical Formula 1, are independently a hydrogen atom; an alkyl of 1-15 carbon atoms; an aromatic ring of 6-30 carbon atoms; or a compound containing at least one selected from the group consisting of an oxygen atom, a nitrogen atom and a sulfur atom.

5. The optical sheet of claim 1, exhibiting an elastic recovery rate of 90% or higher.

6. The optical sheet of claim 1, wherein D₁ meets the following mathematical formula 2:
$${D}_{1} > \frac{D}{8} \qquad Mathematical Formula 2$$

7. The optical sheet of claim 1, wherein D₁ meets the following mathematical formula 3:
$${D}_{1} > \frac{D}{6} \qquad Mathematical Formula 3$$

8. The optical sheet of claim 1, wherein D₁ may meet the following mathematical formula 4:
$${D}_{1} > \frac{D}{3} \qquad Mathematical Formula 4$$

9. The optical sheet of claim 1, wherein the curable resin composition further comprises a UV-curable monomer, a photoinitiator, and an additive.

10. The optical sheet of claim 1, wherein the structured surface of the resin cured layer has a plurality of steric structures arranged in a linear or non-linear pattern thereon.

11. The optical sheet of claim 1, comprising a substrate layer.

12. The optical sheet of claim 1, wherein the structured surface of the resin cured layer has a plurality of steric structures, each taking a form of a polyhedron, a cylinder, a curved cylinder, or a combination thereof, with a polygonal, semicircular, or semi-oval cross section.

13. The optical sheet of claim 1, wherein the metal oxide nanoparticles are made of at least one metal oxide selected from the group consisting of Al₂O₃, TiO₂, ZrO₂, In₂O₃, SnO₂, Y₂O₃, CaO, MgO, and CeO₂.

14. The optical sheet of claim 1, wherein the metal oxide nanoparticles are contained in an amount of 5-90%, based on the total weight of the resin cured layer.

15. The optical sheet of claim 1, wherein the metal oxide nanoparticles are contained in an amount of 10-70%, based on the total weight of the resin cured layer.

16. The optical sheet of claim 1, wherein the organic compound is contained in an amount of 10-70% by weight, based on the total weight of the resin cured layer.

17. The optical sheet of claim 1, having a refractive index of 1.53-1.65.
